(19) United States
(12) Patent Application Publication
(10) Pub. No.: US 2011/0107933 A1
(43) Pub. Date: May 12, 2011

(54) POLYESTER FILM WITH ADHESIVE PROPERTIES

(75) Inventors: Satoshi Yamamoto, Lyon (FR); Hideaki Maeba, Fuwa-gun (JP); Nao Yokota, Saunderstown, RI (US); Roberto Siu, Providence, RI (US)

(73) Assignee: TORAY PLASTICS (AMERICA), INC., North Kingstown, RI (US)

(21) Appl. No.: 12/939,795

(22) Filed: Nov. 4, 2010

Related U.S. Application Data
(60) Provisional application No. 61/259,596, filed on Nov. 9, 2009.

(51) Int. Cl. B41F 3/34; B41M 5/382; B41M 5/41; B41M 5/42

(52) U.S. Cl. 101/492; 428/355 EP; 428/220; 428/336; 428/32.8

(57) ABSTRACT

A multilayer composite film for sublimation type dye transfer imaging includes a polyester base layer and an adhesive layer onto which an ink layer of the sublimation dye can be placed. The adhesive layer includes an acrylic resin, an epoxy resin monomer and a crosslinking agent. The components of the adhesive layer preferably are water soluble or water dispersible.

This application claims benefit of U.S. provisional patent application No. 61/259,596 filed Nov. 9, 2009.

### FIELD OF THE INVENTION

This invention relates to a polyester-based composite film. More specifically, it relates to a polymeric film with a polyester layer coated with a crosslinkable acrylic and epoxy resin adhesive suitable for sublimation type thermal transfer of dye to color images of a print medium, for example as in the printing of digital photographs onto paper.

### BACKGROUND OF THE INVENTION

A sublimation type transfer printing method basically involves providing a print medium onto which an image is to be transferred and superimposing a dye-coated film on the print medium. Minute printing elements are contacted with the surface of the medium/film assembly and are individually heated. This causes the solidified dye on the film to sublime (i.e., vaporize directly from the solid state) and transfer to the adjacent print medium. The amount of dye transfer is related to the amount of heating by each element. Usually this printing method is used in color image transfer in which successive transfer steps with different monochromatic dye-coated films, typically cyan, magenta and yellow, are employed to deposit a full color image onto the print medium. Sublimation type thermal transfer printing has many applications, such as printing images on plastic sheet, fabric and paper. Typical examples of image transferred products are plastic credit cards and paper prints of digital photographs.

The film for sublimation dye transfer typically includes a heat-resistant polymeric base layer. Polyester is a preferred composition for the base layer because of its stability at printing temperatures and strength in very thin form. In general, a polyester film has poor adhesion characteristics because of high crystal orientation. Consequently, dye directly deposited onto polyester film is not adequately bonded. Methods of treating the surface of polyester film, such as corona treatment, typically fail to provide sufficient adhesion. Dye not sufficiently adhered to the base layer does not produce quality images,

To improve dye adhesion, sublimation dye transfer film with a polyester base can further include a layer of adhesive adjacent to the polyester layer and between it and the solidified dye. The adhesive binds dye to the polymeric substrate such that the dye-polymer film composite can be manipulated in the printing process without loss of the dye yet permits controlled sublimation of the dye onto the print medium surface to create the desired product image.

JP-A 1-171988 discloses a biaxially oriented polyester film for a sublimation-type thermosensitive image transfer recording material obtained by applying a coating solution, to at least one side of a polyester film and stretching the resulting film. The solution contains a reaction product obtained by polymerizing a compound having both a specific substituent composition and a polymerizable carbon-carbon double bond in an aqueous solution or a water dispersion of a polyester. The reference discloses biaxially orienting the coated polyester film by stretching in one direction to 2 to 6 times at 60° C. to 130° C., subsequently stretching the coated film to 2 to 6 times in a direction perpendicular to the one direction at 80° C. to 130° C., and then heating the biaxially stretched film at 150° C. to 250° C. for 1 to 600 seconds.

JP-A 3-67695 discloses a polyethylene terephthalate film or polyethylene naphthalate film having an adhesive layer, which has been simultaneously stretched and heated, as a base film for a thermal transfer sheet. Examples disclose that the film is stretched to 4 times in a longitudinal direction at 80° C., to 4 times in a transverse direction at 110° C. and then heated at 210° C.

JP-A 3-106691 discloses a polyester film treated for easy adhesion for use as a base sheet of a thermal transfer sheet capable of forming both clear gradational images and clear characters or other similar images. The treated polyester film has an extremely thin (i.e., 0.001 to 1 μm), uniform adhesive layer thereon. The adhesive layer is formed, for example, by preparing an aqueous dispersion or organic solvent solution of a heat-curable, catalytically curable, ionizing radiation-curable or otherwise crosslinkable resin such as polyurethane resin and acrylic resin, applying the resultant coating liquid to the film, for example by blade coating, and drying the coating liquid thus applied.

Recent developments aiming to increase the speed of sublimation dye transfer printing cause the printing elements to be heated to higher temperatures albeit for short duration. The adhesive layer should thus have good heat resistance while providing proper adhesion to an ink layer at the time of heating. If adhesion is too low, color density and gradation become unacceptable. Furthermore, the increased quantity of heat received by a transfer film can cause large deformation of the polymeric base layer which results in an unclear image, a wrinkled film or, in an extreme case, a printing failure. Utilizing an adhesive layer of an ordinary polyester, acrylic or urethane resin, or of a mixture of a polyester resin and an acrylic resin improves adhesion but gives inferior moisture resistance, water resistance, solvent resistance and blocking resistance.

To reduce these drawbacks, polyester films incorporating a primer layer with crosslinking agent have been used, as in U.S. Pat. No. 6,391,441, U.S. Pat. No. 5,863,641, JP-A 8-11447 and JP-A 9-175046, which are summarized as follows.

U.S. Pat. No. 6,391,441 discloses an adhesive polyester film which is particularly useful as a base layer for a sublimation-type thermosensitive image transfer recording material and which comprises a biaxially oriented polyester film base layer and an adhesive layer. The base layer has no point at which the gradient of its temperature-dimensional change curve changes from a positive value to a negative value when temperature is elevated from the glass transition temperature of the polyester to 240° C. and does not show a dimensional change of more than 5%. The adhesive layer is made from (i) a water-soluble or water-dispersible resin of a polyester modified by a vinyl resin or (ii) a crosslinked resin of a mixture of a water-soluble or water-dispersible acrylic resin, a water-soluble or water-dispersible polyester resin and an epoxy resin crosslinking agent.

U.S. Pat. No. 5,863,641 also discloses a biaxially oriented polyester film for heat-sublimation transfer printing in which the polyester film has a surface coating layer formed from an aqueous acrylic resin (A), an aqueous polyester (B) and an aqueous epoxy compound (C), dry weights of which satisfy the following relationships: 0.30≦W_{A}≦0.90, 0.10≦W_{B}≦0.50, 0.05≦W_{C}≦0.30 and 0.25≦W_{C}/W_{B}≦2 wherein W_{A}, W_{B}, W_{C} are dry weight fractions of components (A), (B), and (C), respectively based on the whole weight of the dry coating layer.

JP-A 8-11447 discloses a polyester film for sublimation type thermal ink transfer printing recording materials having an adhesive coating layer and which film provides a sublimation transfer type ink layer in the surface, and which ink layer satisfies the following relationships: 0.15≦A≦0.75, 0.10≦B≦0.60, 0.10≦C≦0.50, and 0.25≦C/B≦0.60, wherein A is the weight percentage of aqueous acrylic content in the coating layer, B is the weight percentage of aqueous polyester content in the coating layer and C is the weight percentage of aqueous oxazoline group content in the coating layer.

JP-A 9-175046 discloses sublimation type thermal ink transfer printing material wherein the adhesive layer is made up of an acrylic resin, a polyester resin and a melamine crosslinking agent in which the melamine crosslinking agent can be added in dry weight percentages from 1% to 50%.

However despite these technologies, it is still desirable to have a sublimation type dye transfer film with good ink adhesion, resistance to water, solvents and blocking while providing high ink migration sensitivity for high quality imaging after thermal transfer.

### SUMMARY OF THE INVENTION

This invention is primarily directed to a sublimation type film for thermal transfer printing. The novel film has a biaxially oriented polyester base layer and an adhesive layer to bond the dye component to the base layer such that superior imaging results are achievable. In particular, the base layer has a specific coating of adhesive that is excellent for adhesion to a sublimation type ink layer, causes less shifting of the ink layer onto an image-receiving paper sheet, and forms a good transferred image. Additionally, the film/adhesive composite permits use of less sublimation dye than typically needed in conventional transfer films.

Accordingly, the present invention provides a sublimation dye transfer film comprising a base layer comprising (A) a base layer comprising biaxially oriented polyester, and (B) an adhesive layer adjacent to one side of the base layer, the adhesive layer comprising an adhesive composition formed from a mixture of (a) an acrylic resin, (b) an epoxy resin and (c) a crosslinking agent.

There is also provided a method of image transfer printing comprising the steps (I) of providing a sublimation dye transfer film comprising (A) abuse layer comprising biaxially oriented polyester, and (B) an adhesive layer adjacent to one side of the base layer, the adhesive layer comprising an adhesive composition formed from a mixture of (a) an acrylic resin, (b) an epoxy resin monomer and (c) a crosslinking agent, (II) applying an ink layer of comprising a sublimation dye to one side of the adhesive layer opposite the base layer, (III) placing the sublimation dye transfer film adjacent a sheet of print medium with the ink layer contacting the sheet, (IV) heating the transfer film effectively to cause sublimation of the dye of the ink layer thereby transferring dye to the sheet to produce an image on the print medium.

### BRIEF DESCRIPTION OF THE DRAWINGS

FIG. 1 is an elevation cross section view of an embodiment of a sublimation dye transfer film according to this invention.

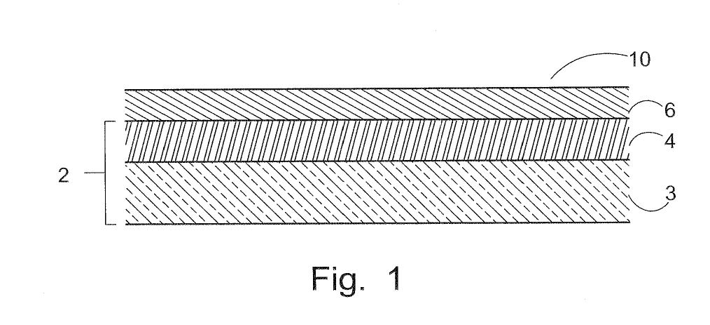

### DETAILED DESCRIPTION OF THE INVENTION

An embodiment of a dye transfer film 10 which incorporates a novel substrate composite 2 according to this invention is illustrated in the drawing FIGURE. The substrate composite has a base layer 3 and an adhesive layer 4 on one side thereof. When the film is used in a dye transfer utility such as for photographic image printing, an ink layer 6 is positioned on the surface of the adhesive layer opposite the base layer. The substrate composite of base layer with adhesive layer can be prepared as an intermediate product. That is, the substrate composite film without the ink layer can be wound-up, packaged, typically as wide rolls, and stored for distribution. Then applying of the ink layer is performed at a later time in a separate procedural operation. Usually, after application of the ink, the dye transfer film 10 is cut to strips of preselected widths and lengths which are packaged as rolls. A preferred end use application for the rolled-up strips of dye transfer film is in interactively operated, automated photograph printing machines.

The major weight fraction of the base layer is a polyester composition. Preferably the base layer comprises at least about 75 wt % polyester. In one aspect the base layer consists essentially of polyester. The “term consist essentially of” means that the composition consists exclusively of the specified components except that additional unspecified component substances which do not materially affect the basic and novel characteristics of this invention can also be present. For example, the polyester used in the present invention may contain lubricants (i.e., particulate “antiblocking” or “slip” agents), stabilizers, colorants, antioxidants and other additives as required in such amounts that do not impair inherent performance thereof.

It is desirable to provide the polyester film with a surface texture such that the center line average roughness measured on the adhesive layer surface is about 0.01 to about 1 μm. Center line average roughness smaller than 0.01 μm typically provides insufficient slipperiness with the result that the obtained film tends to wrinkled or stick in a thermal printing head. Center line average roughness larger than 1 μm, typically usually interferes with heat conductivity during printing such that a satisfactory image cannot be obtained.

Any conventional polyester can be used for the base layer. As used herein the term “polyester” is preferably intended to refer to any thermoplastic film-forming polyester and co-polyester comprising alkylene terephthalate or alkylene naphthalenate as the main recurring units in the polymer chain.

Polyesters comprising alkylene terephthalate as the main recurring units in the polymer chain are preferred. These polyesters are produced mainly by the polycondensation of terephthalic acid or an ester-forming derivative thereof with an alkylene dihydroxyl compound. Examples of the alkylene dihydroxyl compounds include ethylene glycol, propylene glycol, butanediol, neopentyl glycol and the ester-forming derivatives thereof.

The copolyesters can comprise these polyalkylene terephthalate groups as the main constituent units and another comonomer. Examples of the comonomers that can be used are dicarboxylic acids such as isophthalic acid, naphthalendicarboxylic acid, cyclohexanedicarboxylic acid, adipic acid, and sebacic acid as well as the substituted derivatives thereof. These dicarboxylic acids can be used in the form of ester-forming derivatives such as lower alcohol esters. Examples of the dihydroxyl compounds for forming the copolyesters include one or more of hydroquinone, dihydroxyphenyl, cyclohexanediol, polyoxyalkylene glycols and the substituted derivatives thereof.

For efficient film processing such as stretching, heat setting, and wind-up operations it is desirable that the film travels smoothly through the material handling equipment without sticking to itself, wrinkling or jamming. Incorporating lubricant into the film can be used to enable smooth film processing. Preferable lubricants are fine particles dispersed within or on the base layer in a manner effective to produce a rough surface texture at a micron or submicron scale. The lubricant can be an inorganic or organic in particulate form having a particle diameter of 0.1 to 5 μm. Representative lubricants are silicon dioxide, calcium carbonate, alumina, kaolin and silicone particles. Preferably the lubricant is present in an amount of 0.03 to 3.0 wt %, and more preferably 0.1 to 1.0 wt % of the base layer.

The sublimation dye transfer film can be lubricated by imparting roughness to the surface of the adhesive layer. Preferably the center line average roughness of the adhesive layer surface should be about of 0.01 to 1 μm. If the center line average roughness is less than about 0.01 μm, sufficient slipperiness cannot be obtained with the result that the film tends to wrinkle or sticking occurs in a thermal printing head. If the center line average roughness is greater than 1 μm, a satisfactory image cannot be obtained due to low heat conductivity at the time of printing. Surface roughness can be obtained by dispersing an appropriate lubricant into the adhesive layer composition. Lubricants such as those described in reference to the base layer can be used.

Typically the ink layer for sublimation-type thermosensitive image transfer printing comprises a sublimable dye dispersed in a resin binder. The adhesive layer primarily improves adhesion between the ink layer and the polyester film. Without wishing to be bound by a particular theory, the adhesive provides compatibility between the polyester of the base layer and the binder resin component of the ink layer as will now be described more fully.

It has been discovered that the unique combination of acrylic resin, epoxy resin and crosslinking agent of this invention provides significantly improved sublimation ink transfer properties. The acrylic component is compatible with the resin binder of the ink layer and thus imparts a high strength bond to the ink. The epoxy component has excellent adhesion to polyester of the base layer. When crosslinked, the epoxy component entraps much less ink than do conventional adhesive compositions such as crosslinked acrylic resin/polyester resin adhesives.

The term “entrap” means binding the ink by the adhesive layer to an extent great enough to hinder desired release of the ink during sublimation transfer to the print image. This is extremely important in modern dye sublimation transfer processing because entrapped ink is susceptible to migrate into a polyester component of a polyester-containing adhesive layer and/or into the polyester base layer. The adhesive layer being preferably as thin as about 10-50 nm provides little separation between the ink layer and the base layer. Very high speed, sublimation transfer processes now in use call for finely-tuned conditions for ink transfer from the ink layer to the print medium to produce vibrant and sharply defined images. Migration of ink into the adhesive and base layers can introduce variation and inconsistency of ink in the ink layer available for transfer to the print medium. Transfer film with excessive ink migration can disturb transfer process precision which tends to produce inferior images. However, the epoxy resin component entraps very little ink, if any, and is a barrier to ink migration.

It is thus evident that the adhesive layer comprises a major weight fraction of a resin formed from the reaction product of a mixture of a) an acrylic resin, (b) an epoxy resin and (c) a crosslinking agent. Preferably adhesive layer composition, is defined by the following relationships: 0.10≦W_{A}≦0.80, 0.10≦W_{B}≦0.50, 0.10≦W_{C}≦0.50 and W_{A}+W_{B}+W_{C}=1.0, in which W_{A}, W_{B}, and W_{C} are the dry weight fractions of components acrylic resin (A), epoxy resin (B), and another crosslinking agent component (C), respectively based on the whole weight of the dry adhesive layer (i.e., after removal of liquid of solution and dispersion from the adhesive layer components). Great preference is given to adhesive layer compositions which consist essentially of acrylic resin, epoxy resin and crosslinking agent therefor. For example, the adhesive layer composition should be free of polyester resin because of the reason mentioned above.

In this invention, the type of the acrylic resin is not specifically limited. Suitable acrylic resins are oligomers or polymers with repeat units derivative of acrylic acid or a substituted acrylic acid, such as methacrylic acid. The derivative can be an esterified acrylic acid or substituted acrylic acid. Representative derivatives of acrylic acid or substituted acrylic acid include alkylacrylate and alkylmethacrylates in which the alkyl group is methyl, ethyl, n-propyl, isopropyl, n-butyl, isobutyl, t-butyl, 2-ethylhexyl, lauryl, stearyl, cyclohexyl, phenyl, benzyl, phenylethyl and blends thereof. The derivative can also be a hydroxyalkyl-substituted. Representative examples include 2-hydroxyethyl acrylate, 2-hydroxyethyl methacrylate, 2-hydroxypropyl acrylate, 2-hydroxypropyl methacrylate and blends thereof. Also the repeat unit can be an amide or amino derivative of acrylic acid or substituted acrylic acid. Representative compositions of these include acrylamide, methacrylamide, N-methyl acrylamide, N-methyl methacrylamide, N-methylol acrylamide, N-methylol methacrylamide, N,N-dimethylol acrylamide, N-methoxymethyl acrylamide, N-methoxymethylmethacrylamide, N-phenyl acrylamide, N,N-diethylamino ethyl acrylate, N,N-diethylamino ethyl methacrylate and blends thereof.

In this invention, the type of the epoxy resin is not specifically limited. Preferably the epoxy resin has a weight per epoxide equivalent (“WPE”) in the range of about 150-200. WPE lower than about 150 tends not to crosslink sufficiently for good ink adhesiveness and sensitivity. WPE higher than about 200 can react excessively and thereby cause adverse film processability and/or poor quality of the biaxially oriented polyester film. Representative examples of epoxy resin suitable for use in this invention include sorbitol polyglycidyl ether-based resin, polyglycerol polyglycidyl ether-based resin, diglycerol polyglycidyl ether-based resin, polyethylene glycol diglycidyl ether-based resin and blends thereof A preferred source of aqueous epoxy resins is Nagase & Co., Ltd., Osaka, Japan under the Denacol® trademark.

In this invention, the type of crosslinking agent is not specifically limited. Representative types of suitable crosslinking agents include oxazoline-based crosslinking agents, melamine-based crosslinking agents, imine-based crosslinking agents such as aziridine-based crosslinking agents, epoxyamide compounds, titanate-based coupling agents, isocyanate-based crosslinking agents, alkylolurea-based compounds such as methylolurea acrylamide-based crosslinking agents and blends thereof. It is desirable that the crosslinking agent have good miscibility with the acrylic resin component. For this reason oxazoline-based crosslinking agents are preferred.

Preference is given to producing the novel film in an environmentally benign manner. Use of organic media for carrying the adhesive components is possible but not preferred because the organic media is ultimately disposed of with environmental consequences. Preferably, each of the acrylic resin, epoxy resin and crosslinking agent is water-soluble or water-dispersible.

Thickness of the adhesive layer is important to provide optimum balance between the adhesiveness of the ink and sensitivity of printed image. A thinner adhesive layer provides the better sensitivity, however, the layer should not be so thin as to fail to hold the ink or allow migration of the ink into and through the adhesive layer as mentioned above. The adhesive layer preferably has a thickness of about 10 nanometers to about 50 nanometers, more preferably about 10 to about 30 nanometers.

The overall thickness of the novel multilayer dye transfer film is preferably about 0.5 to about 10 μm, and more preferably about 1 to about 6 μm. There is a recent trend toward reduced printer size and increased printing speed. Very thin dye transfer film, preferably as thin as practicable, is more compatible in such conditions and is especially desirable. Usually it is difficult to produce a polyethylene terephthalate film less than 1.5 μm thick. Polyethylene-2,6-naphthalate film has higher strength than the polyethylene terephthalate film and therefore can be made with a thickness as little as about 0.5 μm. Consequently polyethylene-2,6-naphthalate can be used for the base layer polyester component, particularly for end use applications that demand very thin film. If the thickness of the film is larger than about 10 μm, it tends to reduce heat conductivity for sublimation dye transfer and thereby limits printing speed.

The base layer can be produced by melt-extruding the layer composition to a film form, and then cooling molten extrudate to obtain a relatively thick, solid film. Typically the thick film is solidified by winding it round a casting drum. Subsequently the solidified thick film is biaxially stretched one or more times to provide the desired small film thickness. The stretching procedure can include heating steps to set and stabilize the film dimensions against shrinkage that might occur during thermal printing operations. In a preferred embodiment, the extruded and solidified film is subjected to (i) stretching to about 3 to about 7 times in a longitudinal direction at a temperature of Tg (i.e., the glass transition temperature of the polyester) to Tg+60° C., (ii) stretching to about 3 to about 5 times in a transverse direction at Tg to Tg+60° C., and thereafter (iii) heating to Tg+50 to Tg+140° C. for 1 to 100 seconds. Optionally the film can be heated again while being relaxed in a transverse direction by 0 to 5%.

The adhesive layer can be applied to the polyester film during biaxial stretching. Preferably the adhesive components will be dissolved or dispersed in a liquid. Preferably the liquid is water. The adhesive solution or dispersion can be applied by conventional techniques such as dip, roller, spray, paint or doctor blade methods, to name a few examples. After application, the liquid can be removed by conventional drying methods, including heat and vacuum, for example to leave a dry coating of adhesive on the base layer. Preference is given to applying the adhesive solution or dispersion to the surface of the film after machine direction stretching and before transverse direction stretching. The once-stretched film with adhesive deposited thereon then conveniently enters a zone, typically an oven, in which temperature is controlled while transverse direction stretching occurs. During this second stretching step and optional relaxation, heating of the film not only appropriately treats the polyester but also conveniently dries residual liquid from the adhesive solution/dispersion and thermally activates crosslinking of the adhesive components. Alternatively, the adhesive can be applied to the polyester base layer after biaxial stretching and optional relaxation have taken place.

Crosslinking of the acrylic and epoxy type adhesive components places the adhesive layer in ideal condition to later accept the ink layer. As mentioned, it is preferred to collect the base layer/adhesive layer composite for distribution. Subsequently, the ink layer can be placed on the adhesive layer. Normally the ink layer is a conventional composition of a sublimation ink pigment uniformly dispersed in a polymeric medium.

Biaxial stretching according to this invention preferably provides the dye transfer film with a highly uniform thickness. Preferably thickness non-uniformity in longitudinal and transverse directions is from about 0 to about 5%, and more preferably about 0 to about 2%. If the thickness non-uniformity is larger than 5%, a uniform back coat or a uniform sublimable ink layer cannot be formed, thereby deteriorating the traveling properties at the time of printing and printing resolution of the film.

### EXAMPLES

This invention is now illustrated by examples of certain representative embodiments thereof, wherein all parts, proportions and percentages are by weight unless otherwise indicated. All units of weight and measure not originally obtained in SI units have been converted to SI units. The entire disclosures of U.S. patents and patent applications identified in this application are hereby incorporated by reference herein.

The following test methods are used in the examples.

(1) Adhesiveness

A 2 micrometers thick sublimation ink layer of HS C ink (The Ink-Tech Co., Ltd.) composed of 50 parts of alkyl acetal polyvinyl alcohol, 30 parts of Color Index Solvent Blue 63, 15 parts of Color Index Solvent Blue 354 and 5 parts of hydrocarbon wax was formed on the surface of the adhesive layer disposed on a polyester base layer of a sample film. 3M Scotch Mending Tape 810 was applied with its adhesive side in contact with the ink layer of the sample. The tape was quickly peeled away. Adhesiveness was visually examined and rated according to the following scheme based on the area of the ink layer removed from the sample. Excellent (“E”): less than 10%, Allowable (“A”): 10-20%. Insufficient (“I”): 20-50%. Unacceptable (“U”): exceeded 50%.

(2) Sensitivity

A sample of the dye transfer film to be tested was applied to SVM-F40L receiver paper (Sony Corporation) with coating side up. Using a DPP-FP75 digital photo printer (Sony Corporation) 100% cyan color was sublimated from the adhesive side of the film to the paper. Cyan color was generated using Adobe Photoshop software with RGB settings of R:0, G:0 and B:256. Color tone was measured by a SpectroEyeLT optical densitometer (Sakata Inx Engineering Co., Ltd.) Acceptable range is at most 0.10 (O.D. value). Sensitivity of 0.08 or less is much preferred.

(3) Thickness of the Coating Layer

This was calculated from an amount of an applied coating solution per m² and a solid concentration of the coating solution.

The following materials were used for compositions of the adhesive layer in the examples of Table 1, described below:

Acrylic-Based Resin:

A: A water-dispersible composition of 75 mol % methyl methacrylate, 22 mol % ethyl acrylate, 2 mol % of n-methylol acrylic amide and 1 mol % of acrylic acid.

Epoxy-Based Resins:

B1: A water-soluble sorbitol polyglycidyl ether (Denacol® EX614B). WPE is 173.

B2: A water-soluble ethylene glycol diglycidyl ether (Denacol® EX810). WPE is 113.

B3: A water-soluble polyglycerol polyglycidyl ether (Denacol® EX512). WPE is 168.

B4: A- water-dispersible cresol-Novolak type epoxy resin emulsion (Denacol® EM160). WPE is 130.

Polyester-Based Resin:

C: A water-soluble composition of 50 mol % terephthalic acid, 40 mol % isophthalic acid and 10 mol % 5-sodium isophthalic acid.

Crosslink Agent:

D1: 55 mol % 1-isopropenyl-2-oxazoline and 45 mol % 1-methoxy-2-propanol.

D2: 99 mol ° A) propylene imine and 1 mol % 2-dimethylaminoethanol.

D3: 70 mol % methylol melamine and 30 mol % isopropyl alcohol.

### Example 1

A mixture with composition of 0.2 parts by weight of 2.6 μm average diameter silica oxide particles (Silicia 310 by Fuji-silica), and 100 parts by weight 0.65 inherent viscosity polyethylene terephthalate was supplied to an extruder and melt compounded at 280° C. (536° F.). A molten polymer sheet was cast on a rotating cooling drum having a temperature of 21° C. (70° F.) to prepare non-stretched film. The thus obtained non-stretched film was introduced into a plurality of heated rolls and stretched at a draw ratio of 6.0 times at 121° C. (250° F.) in a longitudinal stretching process. Then, an adhesive coating solution of the composition of components A-D as shown in Table 1 was applied on one side of the uniaxially oriented film. This coated film was led into a tenter which grasps both end positions of film by clips, and therein the coating solution was dried and the film was preheated at a temperature of 100° C. (212° F.). Then the film was stretched in the transverse direction at a draw ratio of 4.0 times and at a temperature of 116° C. (240° F.). After that, the film was heat treated at 230° C. (446° F.) and relaxed 4.0% by length in the transverse direction, to obtain adhesive coated biaxially oriented polyester film with 4.0 micrometers total thickness including 20 nanometers of the coating layer. A sublimation ink layer was applied as described in the adhesiveness method, above. Adhesiveness and sensitivity of the film were evaluated, and the results are shown in Table 2.

### Examples 2-9 and Comparative Examples 1-13

The procedure of Example 1 was repeated except that the compositions of the adhesive coating solution and thickness of the coating layer were changed as shown in Table 1. Adhesiveness and sensitivity of the coating layer of the film were evaluated and the results are shown in Table 2.

In Comp. Exs. 1-7, a substantial amount of polyester-based resin was included in the adhesive layer. Also, crosslinking agent was absent from the adhesive layer composition of Comp. Exs. 1, 2 and 8, epoxy-based resin was absent from the adhesive layer composition of Comp. Exs. 5, 7 and 9, and neither epoxy-based resin nor crosslinking agent were present in Comp. Ex. 6. In Comp. Ex. 13 the ink layer was deposited directly onto the polyester base layer without any adhesive layer. All of the operative Examples 1-9 demonstrate that superior adhesiveness and fully acceptable sensitivity was obtained according to this invention. Furthermore, most of the operative examples (except Exs. 3, 4, 8 and 9) exhibited a much preferred sensitivity of 0.08 or less. Although Ex. 9 sensitivity fluctuated above the goal occasionally, sensitivity performance was predominantly acceptable.

Although specific forms of the invention have been selected in the preceding disclosure for illustration in specific terms for the purpose of describing these forms of the invention fully and amply for one of average skill in the pertinent art, it should be understood that various substitutions and modifications which bring about substantially equivalent or superior results and/or performance are deemed to be within the scope and spirit of the following claims.

TABLE 1

| | A | B1 | B2 | B3 | B4 | C | D1 | D2 | D3 | Thickness | | Sensitivity |
|---|---|---|---|---|---|---|---|---|---|---|---|---|
| | (ppw)¹ | (ppw) | (ppw) | (ppw) | (ppw) | (ppw) | (ppw) | (ppw) | (ppw) | (nm) | Adhesiveness | (O.D.)² |
| Ex. 1 | 20 | 40 | | | | | 40 | | | 20 | E | 0.05 |
| Ex. 2 | 40 | 30 | | | | | 30 | | | 20 | E | 0.05 |
| Ex. 3 | 20 | | 40 | | | | 40 | | | 20 | E | 0.09 |
| Ex. 4 | 70 | | 15 | | | | 15 | | | 20 | A | 0.10 |
| Ex. 5 | 20 | | | 40 | | | 40 | | | 20 | E | 0.06 |
| Ex. 6 | 20 | | | | 40 | | 40 | | | 20 | A | 0.08 |
| Ex. 7 | 20 | 40 | | | | | | 40 | | 20 | E | 0.07 |
| Ex. 8 | 20 | 40 | | | | | | | 40 | 20 | E | 0.10 |
| Ex. 9 | 20 | 40 | | | | | 40 | | | 40 | E | 0.09-0.15³ |
| Comp. Ex. 1 | 30 | 10 | | | | 60 | | | | 20 | E | 0.19 |
| Comp. Ex. 2 | 30 | 30 | | | | 40 | | | | 20 | E | 0.16 |
| Comp. Ex. 3 | 30 | 20 | | | | 30 | 20 | | | 20 | E | 0.15 |
| Comp. Ex. 4 | 30 | 20 | | | | 30 | | 20 | | 20 | E | 0.16 |
| Comp. Ex. 5 | 46 | | | | | 40 | | 20 | | 20 | E | 0.17 |
| Comp. Ex. 6 | 50 | | | | | 50 | | | | 20 | I | 0.18 |
| Comp. Ex. 7 | 30 | | | | | 60 | | | 10 | 20 | E | 0.25 |
| Comp. Ex. 8 | 67 | 33 | | | | | | | | 20 | E | 0.26 |
| Comp. Ex. 9 | 67 | | | | | | 33 | | | 20 | I | 0.09 |
| Comp. Ex. 10 | | | | | 50 | | 50 | | | 20 | I | 0.07 |
| Comp. Ex. 11 | 20 | 40 | | | | | 40 | | | 5 | I | 0.06 |
| Comp. Ex. 12 | 20 | 40 | | | | | 40 | | | 60 | E | 0.20 |
| Comp. Ex. 13 | — | — | — | — | — | — | — | — | — | — | U | .05 |

¹parts by weight
²Optical Density
³mostly acceptable, occasionally high sensitivity

What is claimed is:

1. A composite film comprising (a) a base layer comprising polyester, and (b) an adhesive layer adjacent to one side of the base layer, the adhesive layer consisting essentially of an adhesive composition formed from a mixture of (A) an acrylic resin, (B) an epoxy resin and (C) a crosslinking agent.

2. The composite film according to claim 1 in which each of the acrylic resin, the epoxy resin monomer and the crosslinking agent is either water-soluble or water-dispersable.

3. The composite film according to claim 1 in which components A, B and C are present in the adhesive layer in dry weight fractions W_{A}, W_{B} and W_{C}, respectively, according to the following relationships 0.10≦W_{A}≦0.80, 0.10≦W_{B}≦0.50, 0.10≦W_{C}≦0.50, and the sum of W_{A}, W_{B} and W_{C} equals 1.0.

4. The composite film according to claim 1 having a thickness of about 0.5-10 μm.

5. The composite film according to claim 1 in which the adhesive layer has a thickness of about 10-50 nanometers.

6. The composite film according to claim 1 in which WPE (weight per epoxide equivalent) of the epoxy resin is about 150-200.

7. The composite film according to claim 1 in which the crosslinking agent is oxazoline.

8. The composite film according to claim 1 in which the crosslinking agent is imine.

9. The composite film according to claim 1 in which the base layer comprises at least about 80 wt % polyethylene terephthalate

10. The a composite film according to claim 1 further comprising a sublimation dye ink layer in direct contact with the adhesive layer opposite the base layer.

11. The composite film according to claim 1 in which the acrylic resin and the epoxy resin of the adhesive layer are crosslinked.

12. The composite film according to claim 1 in which the base layer is biaxially stretched.

13. A method of image transfer printing comprising the steps of
(I) providing a sublimation dye transfer film comprising (a) a biaxially oriented base layer and (b) an adhesive layer adjacent to one side of the base layer, the adhesive layer comprising an adhesive composition formed from a crosslinked mixture consisting essentially of an acrylic resin and an epoxy resin,
(II) applying an ink layer comprising a sublimation dye in contact with the adhesive layer opposite the base layer,
(III) placing the sublimation dye transfer film adjacent a print medium with the ink layer contacting the print medium,
(IV) heating the transfer film effectively to cause sublimation of the dye of the ink layer thereby transferring dye to produce an image on the print medium.

14. A method of making a composite film comprising the steps of:
(I) providing a base layer of a polyester film,
(II) providing a mixture of an acrylic resin, an epoxy resin and a crosslinking agent in an aqueous medium,
(III) coating one side of the polyester film with the mixture,
(IV) removing water from the mixture thereby forming an adhesive layer on the polyester film, and
(V) activating the crosslinking agent of the adhesive layer effectively to crosslink the acrylic resin and the epoxy resin.

15. The method of claim 14 which further comprises the step of biaxially stretching the composite film.

16. The method of claim 14 which further comprises the steps of (VI) providing an ink-bearing composition comprising sublimation transfer dye dispersed in a polymeric medium, and (VII) forming an ink layer of the ink-bearing composition on a side of the composite film in direct contact with the adhesive layer.
